(19) United States
(12) Patent Application Publication
(10) Pub. No.: US 2026/0343338 A1
(43) Pub. Date: Oct. 29, 2026

(54) SUCCESSFUL PSCELL REPORT TRANSFER

(71) Applicant: TELEFONAKTIEBOLAGET LM ERICSSON (PUBL), Stockholm (SE)

(72) Inventors: Julien Muller, RENNES (FR); Tahmineh Torabian Esfahani, SOLLENTUNA (SE); Ali Parichehrehteroujeni, LINKÖPING (SE); Luca Lunardi, GENOVA (IT)

(21) Appl. No.: 19/115,334

(22) PCT Filed: Sep. 27, 2023
(86) PCT No.: PCT/IB2023/059619

§ 371 Date: Mar. 26, 2025

Related U.S. Application Data
(60) Provisional application No. 63/410,505, filed on Sep. 27, 2022.

(51) Int. Cl. H04W 36/00

(52) U.S. Cl. CPC H04W 36/0069

(57) ABSTRACT

Methods and systems are described for transmitting and indicating availability of, SPRs (Successful Primary Secondary Cell (PSCell) Reports). In some embodiments, a first network node can receive an SPR availability information from a UE. The first network node can then fetch the SPR from the UE and analyze whether the SPR should be shared with another network node. The SPR can then be shared if deemed necessary or appropriate.

### CROSS REFERENCE TO RELATED INFORMATION

This application claims the benefit of U.S. of America priority application No. 63/410,505 filed on Sep. 27, 2022, titled “Successful PSCell Report Transfer.”

### TECHNICAL FIELD

The present disclosure generally relates to the technical field of wireless communications and more particularly to PSCell changes.

### BACKGROUND

### Wireless Communication Systems in 3GPP

FIG. 1 illustrates a simplified wireless communication system, with a user equipment (UE) 102, which communicates with one or multiple access nodes 103-104, which in turn is connected to a network node 106. The access nodes 103-104 are part of the radio access network (RAN) 100.

For wireless communication systems pursuant to 3GPP Evolved Packet System, EPS (also referred to as Long Term Evolution, LTE, or 4G) standard specifications, such as specified in 3GPP TS 36.300 and related specifications, the access nodes 103-104 correspond typically to an Evolved NodeB (eNB) and the network node 106 corresponds typically to either a Mobility Management Entity (MME) and/or a Serving Gateway (SGW). The eNB is part of the radio access network 100, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

For wireless communication systems pursuant to 3GPP 5G System, 5GS (also referred to as New Radio, NR, or 5G) standard specifications, such as specified in 3GPP TS 38.300 and related specifications, on the other hand, the access nodes 103-104 correspond typically to a 5G NodeB (gNB) and the network node 106 corresponds typically to either an Access and Mobility Management Function (AMF) and/or a User Plane Function (UPF). The gNB is part of the radio access network 100, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs can also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this disclosure; however, it should be noted that most of the solutions/features described for LTE and NR in this disclosure also apply to LTE connected to 5GC. In this disclosure, when the term LTE is used without further specification it refers to LTE-EPC.

### Self-Organizing Networks in 3GPP

A Self-Organizing Network (SON) is an automation technology designed to make the planning, configuration, management, optimization, and healing of mobile radio access networks simpler and faster. SON functionality and behavior has been defined and specified in generally accepted mobile industry recommendations produced by organizations such as 3GPP (3rd Generation Partnership Project) and the NGMN (Next Generation Mobile Networks).

In 3GPP, the processes within the SON area are classified into Self-configuration process and Self-optimization process. Self-configuration process is the process where newly deployed nodes are configured by automatic installation procedures to get the necessary basic configuration for system operation.

This process works in pre-operational state. Pre-operational state is understood as the state from when the eNB is powered up and has backbone connectivity until the RF transmitter is switched on.

As illustrated in FIG. 2, functions handled in the pre-operational state like: Basic Setup; and Initial Radio Configuration; are covered by the Self Configuration process.

Self-optimization process is defined as the process where UE and access node measurements and performance measurements are used to auto-tune the network. The self-optimization process works in operational state. Operational state is understood as the state where the RF interface is additionally switched on.

As described in FIG. 2, functions handled in the operational state like: Optimization/Adaptation; are covered by the Self Optimization process.

In LTE, support for Self-Configuration and Self-Optimisation is specified, as described in 3GPP TS 36.300 section 22.2, including features such as Dynamic configuration, Automatic Neighbour Relation (ANR), Mobility load balancing, Mobility Robustness Optimization (MRO), RACH optimization and support for energy saving.-

In NR, support for Self-Configuration and Self-Optimisation is specified as well, starting with Self-Configuration features such as Dynamic configuration, Automatic Neighbour Relation (ANR) in Rel-15, as described in 3GPP TS 38.300 section 15. In NR Rel-16, more SON features are being specified for, including Self-Optimisation features such as Mobility Robustness Optimization (MRO).

### Successful Handover Report

Successful handover (HO) report (SHR) has been standardized as part of 3GPP Rel 17 TS e.g., see RRC spec 38.331(V17.0.0 ). The main purpose of the successful HO report is to enable the network nodes to deduce sub-optimal performance of the underlaying procedures executed during the HO procedure.

The network node, upon being interested in SHR, can configure the UE to report the SHR after successful execution of a HO, if at least one of the SHR triggering conditions/thresholds is met. The SHR triggering thresholds are defined as following:
Whether the T304 timer value was above a certain threshold at the time of successful HO execution (thresholdPercentageT304);
Whether the T310 timer value was above a certain threshold at the time of successful HO execution (thresholdPercentageT310);
Whether the T312 timer value was above a certain threshold at the time of successful HO execution (thresholdPercentageT312);
Whether the UE experienced RLF at source node while performing a DAPS HO (sourceDAPS-FailureReporting).

When storing the successful handover report, the UE may include various information to aid the network to optimize the handover, such as measurements of the neighbouring cells, the fulfilled condition that triggered the successful handover report (e.g., threshold on T310 exceeded, specific RLF issue in the source while doing DAPS HO), etc.

The SHR can be configured by a certain serving cell, and when triggering conditions for SHR logging are fulfilled, the UE stores this information until the NW requests it. In particular, the UE may indicate availability of SHR information in certain RRC message, such as RRCReconfigurationComplete, RRCReestablishmentComplete, RRCSetupComplete, RRCResumeComplete, and the network may request such information via the UEInformationRequest message, upon which the UE transmits the stored SHR in the UEInformationResponse message.

### Multi-Radio Dual Connectivity

Multi-Radio Dual Connectivity (MR-DC) describes the scenario where a UE that is capable of connecting to multiple nodes utilizes the multiple resources to increase throughput as described in TS 37.340. This is a generalization of the intra-E-UTRA (Evolved Universal Terrestrial Radio Access) Dual connectivity described in TS 36.300.

When a UE is in DC mode, one node acts as the Master node (MN) and the other node acts as a Secondary node (SN). The MN and SN are connected via a network interface and at least the MN is connected to the core network. Details on MR-DC can be found in TS 38.401. The primary cell in MN is known as PCell and the primary cell in SN is known as PSCell.

### Successful PSCell Report (SPR)

The ongoing rel-18 Work Item “New WID on further enhancement of data collection for SON (Self-Organising Networks)/MDT (Minimization of Drive Tests) in NR standalone and MR-DC (Multi-Radio Dual Connectivity)” has the following objective: Support of SON/MDT enhancements for Successful PScell change report.

The Successful PScell (change) report, or SPR, is likely to have the same properties as the SHR described above, but is related to PSCell Change/Addition events. Which means that the UE will generate an SPR, if events configured by the network are triggered during a PSCell Change or PSCell Addition. The UE will advertise the presence of the SPR to the network, which will in return fetch it. Network signaling will then be used to send the SPR to the node which configured the event which triggered the creation of the SPR. This SPR will finally be used by the network node to optimize PSCell Change/Addition.

There currently exist certain challenges. Contrary to the SHR, the SPR may be useful for both MN and SN optimization, because PSCell Change can be MN-initiated or SN-initiated. So even if SHR design is taken as baseline for SPR, some questions are still unresolved. It is not clear if or how the SN will be able to fetch the SPR. And if so, it is not clear how it will be sent to MN. It is also unclear how SPR availability will be signaled to the network. Furthermore, it is unclear how the MN will know when/how to fetch the SPR, when SPR availability is signaled only to the SN in RRC Reconfiguration Complete. These questions need to be answered and the corresponding solutions need to be standardized.

### SUMMARY

One embodiment under the present disclosure comprises a method performed by a UE for indicating availability of a SPR. The method comprises advertising an SPR availability information to a network node. It also optionally comprises transmitting the SPR to the network node.

Another embodiment of a method under the present disclosure is a method performed by a first network node for transmitting a SPR. The method comprises receiving an SPR availability information from a UE; fetching the SPR from the UE; and analyzing the received SPR and determining that the SPR needs to be transferred to a second network node. The method further optionally comprises transmitting the SPR to the second network node.

A further embodiment under the present disclosure comprises a method performed by a first network node for indicating availability of a SPR. The method comprises receiving an SPR availability information from a UE; and transmitting, to a second network node, an indication that the SPR is available at the UE. The method can optionally further include receiving the SPR from the second network node.

A further embodiment under the present disclosure comprises a method performed by a first network node for receiving a SPR. The method comprises receiving, from a second network node, an indication that a SPR is available at a UE; fetching, from the UE, the SPR; and analyzing the fetched SPR and detecting if the SPR should be sent to the second network node. The method can optionally further include transmitting the SPR to the second network node.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates a simplified wireless communication system;

FIG. 2 illustrates self-configuration and self-optimization functionality;

FIG. 3 illustrates a flow-chart of a method embodiment under the present disclosure;

FIG. 4 illustrates a flow-chart of a method embodiment under the present disclosure;

FIG. 5 illustrates a flow-chart of a method embodiment under the present disclosure;

FIG. 6 illustrates an embodiment of messaging under the present disclosure;

FIG. 7 illustrates a flow-chart of a method embodiment under the present disclosure;

FIG. 8 illustrates a flow-chart of a method embodiment under the present disclosure;

FIG. 9 illustrates a flow-chart of a method embodiment under the present disclosure;

FIG. 10 illustrates a flow-chart of a method embodiment under the present disclosure;

FIG. 11 illustrates a flow-chart of a method embodiment under the present disclosure;

FIG. 12 shows a schematic of a communication system embodiment under the present disclosure;

FIG. 13 shows a schematic of a user equipment embodiment under the present disclosure;

FIG. 14 shows a schematic of a network node embodiment under the present disclosure;

FIG. 15 shows a schematic of a host embodiment under the present disclosure;

FIG. 16 shows a schematic of a virtualization environment embodiment under the present disclosure; and

FIG. 17 shows a schematic representation of an embodiment of communication amongst nodes, hosts, and user equipment under the present disclosure.

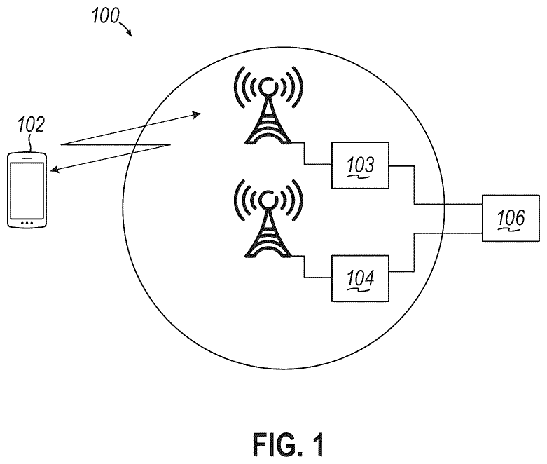

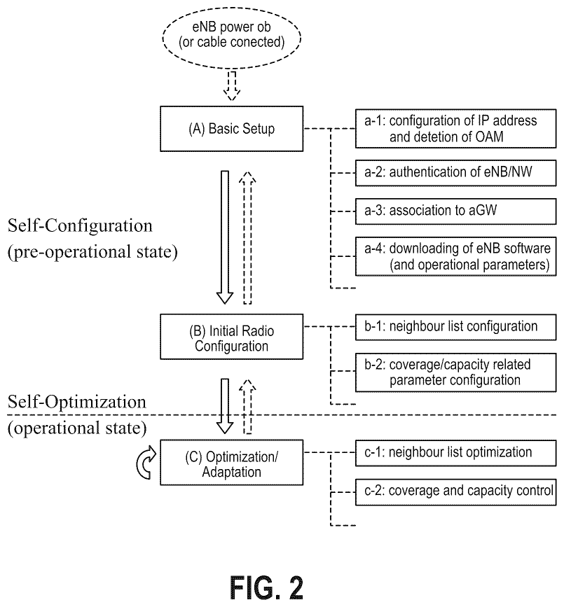

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

Certain aspects of the disclosure and their embodiments may provide solutions to the challenges identified above or other challenges. Several possible embodiments include the following:
SN fetching SPR and sends it to MN if PSCell change was MN-initiated;
UE indicating SPR availability in next messages to the MN;
SN signaling to the MN that SPR is to be fetched; and
MN fetches the SPR and sends it to the SN if PSCell change was SN-initiated. Some of these embodiments, and other embodiments and variations contemplated herein will now be described more fully with reference to the accompanying drawings. Embodiments are provided by way of example to convey the scope of the subject matter to those skilled in the art.

Certain embodiments may provide one or more of the following technical advantages. Under the present disclosure and its embodiments, both MN and SN should be able to receive the SPR when generated by the UE. Furthermore, SHR design (UE inform the network of SPR availability in RRCReconfigurationComplete message and MN fetches the SPR) can be implemented or not implemented, as desired by a user or network.

In this disclosure the terms network nodes and RAN nodes have been used interchangeably. Furthermore, the term MN and SN can be different from UE perspective, i.e., same network node can act as MN and SN simultaneously for different UEs. The Successful PSCell Report indicates a report from the UE in response to Successful PSCell report configuration and may have a different name in certain systems and embodiments.

### SN Fetches SPR (MN-Initiated PSCell Change)

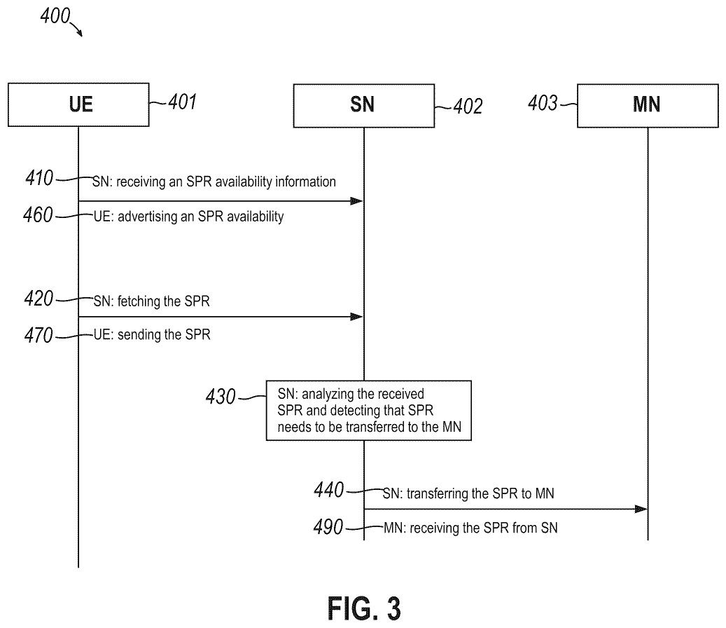

In certain embodiments, the SN fetches the SPR and sends it to the MN if PSCell change was MN-initiated. The approaches taken under these embodiments include the possibility for the SN to fetch and analyze the SPR, e.g., the part where the SN determines if SPR needs to be transferred, by analyzing triggers contained in the SPR. Another aspect is new inter-node signaling to transfer SPR from SN to MN, especially via the UE-associated signaling. FIG. 3 illustrates a possible method embodiment 400, including steps from the perspective of the SN 402, UE 401, and MN 403.

Under method 400, one aspect can include steps performed by a network node acting as SN for a UE in Dual Connectivity operation. Step 410 is receiving an SPR availability information from the UE. Step 420 is fetching the SPR from the UE. Step 430 is analyzing the received SPR and determining that SPR needs to be transferred to MN. Step 440 is transferring the SPR to the MN.

One alternative embodiment under method 400 comprises steps performed by a network node acting as Master Node (MN) for a UE in Dual Connectivity operation. Step 480 is receiving an SPR from the SN.

Another aspect under method 400 can include steps performed by a UE in Dual Connectivity operation. Step 460 is advertising an SPR availability information to the SN. Step 470 is sending the SPR to the SN, alternatively, letting the SN fetch the SPR.

These method steps described above can each comprise different variations.

Step 410/460, receiving/advertising an SPR availability information from the UE to the SN, can comprise different variations. In one embodiment, the SPR information availability is included in the RRCReconfigurationComplete message. In one variation, the RRCReconfigurationMessage can be sent directly from UE to SN (via SRB3). In another variation, the RRCReconfigurationMessage can be sent via the MN, in S-NODE RECONFIGURATION COMPLETE message from MN to SN (if received by the MN via SRB1). In another embodiment, the SPR information availability is included in a RRC message e.g., ULInformationTransferMRDC message. In one variation, the ULInformationTransferMRDC can be directly sent from UE to SN (via SRB3). In another variation, the ULInformationTransferMRDC can be sent via the MN, in S-NODE RECONFIGURATION COMPLETE message from MN to SN (if received by the MN via SRB1). In a further embodiment, the SPR information availability is included in the UEAssistanceInformation message. In one variation the UEAssistanceInformation can be sent directly from UE to SN (via SRB3). In another variation the UEAssistanceInformation can be sent through MN to the SN via SRB1. In an additional embodiment the network node configures the UE how and on which signal e.g., RRCReconfigurationComplete message or UEAssistanceInformation message to send the SPR availability indication. In one variation the network requests the UE to send the SPR availability indication to the SN via RRCReconfigurationComplete message. In another variation the network requests the UE to send the SPR availability indication to the SN via UEAssistanceInformation message via SRB1 or via SRB3.

Step 430, analyzing the received SPR and determining that SPR needs to be transferred to MN, can comprise different variations. In one embodiment, the information that SPR needs to be transferred to MN is represented by the information that the PSCell Change was triggered by the MN, this information being contained in the SPR itself. In another embodiment, the information that SPR needs to be transferred to MN is represented by one or several triggers contained in the SPR, these triggers being configured by the MN prior to SPR generation. In another embodiment, the information that SPR needs to be transferred to MN which is represented by a flag triggering SN to send the SPR to MN upon reception of the SPR via SRB3.

Step 440/490, transferring the SPR to the MN, can comprise different variations. In one embodiment, UE-associated signaling is used, which can comprise, e.g., a new UE-associated XnAP message; an XnAP S-Node Modification Required message; or an XnAP RRC Transfer message. In another embodiment, a non UE-associated message is used, which can comprise, e.g., an XnAP Access and Mobility Indication message; or a new non UE-associated message.

An example of a possible implementation in TS 38.423 of aspects of method 400 of FIG. 3, incorporating an RRC transfer, is described below.

The purpose of the RRC Transfer procedure is to deliver a PDCP-C PDU encapsulating an LTE RRC message or NR RRC message to the S-NG-RAN-NODE that it may then be forwarded to the UE, or from the S-NG-RAN-NODE, if it was received from the UE. The delivery status may also be provided from the S-NG-RAN-NODE to the M-NG-RAN-NODE using the RRC Transfer.

The procedure is also used to enable transfer of one of the following messages from the M-NG-RAN-NODE to the S-NG-RAN-NODE, when received from the UE:
the NR RRC message container with the NR measurements;
the E-UTRA RRC message container with the E-UTRA measurements;
the NR RRC message container with the NR failure information;
the NR RRC message container with the RRCReconfigurationComplete message;
the NR RRC message container with the UE assistance information;
the NR RRC message container with the PSCell Change Report.

In case of RACH based SDT without UE context relocation, this procedure is also used to deliver a PDCP-C PDU encapsulating an NR RRC message between the new NG-RAN node and the old NG-RAN node. The procedure can use UE-associated signalling.

### UE Indicating SPR Availability

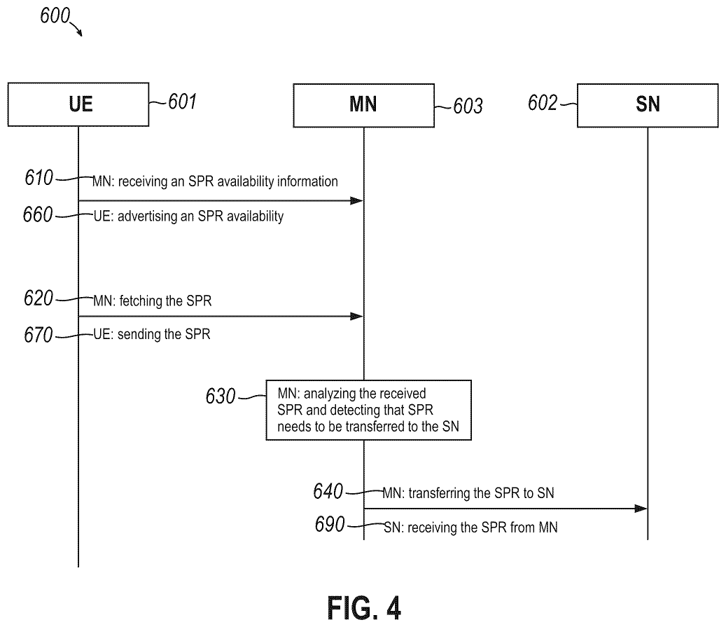

As discussed above, another embodiment includes the UE indicating SPR availability in next messages to MN. Approaches taken under this embodiment can focus on the UE using an RRC message (e.g., UEInformation TransferMRDC) sent to the MN to inform the MN that an SPR is available. Another aspect can include the MN analyzing the SPR to determine if SPR needs to be transferred, by analyzing triggers contained in SPR. FIG. 4 illustrates a possible method embodiment 600, including steps from the perspective of the SN 602, UE 601, and MN 603.

Under one embodiment under method 600, one aspect can include steps performed by a network node acting as MN for a UE in Dual Connectivity operation. Step 610 is receiving an SPR availability information from the UE. Step 620 is fetching the SPR from the UE. Step 630 is analyzing the received SPR and determining that SPR needs to be transferred to SN. Step 640 is transferring the SPR to the SN. Step 610 can comprise different variations. In one embodiment, the SPR information availability is included in next RRCReconfigurationComplete message sent to the MN. In another embodiment, the SPR information availability is included in a RRC message e.g., UEInformationTransferMRDC message. Step 630 can comprise different variations. In one embodiment, the information that SPR needs to be transferred to SN is represented by the information that the PSCell Change was triggered by the SN, this information being contained in the SPR itself. In another embodiment, the information that SPR needs to be transferred to SN is represented by one or several triggers contained in the SPR, these triggers being configured by the SN prior to SPR generation. Step 640 can comprise different variations. In one embodiment, UE-associated signaling is used, such as: a new UE-associated XnAP message; a XnAP S-Node Modification Request message; or a XnAP RRC Transfer message. In another embodiment, non UE-associated message is used, such as: XnAP Access and Mobility Indication message; or a new non UE-associated message.

Another embodiment under method 600 can include steps performed by a UE in Dual Connectivity operation. Step 660 is advertising an SPR availability information to the MN. Step 670 can be the UE sending the SPR to the MN (alternatively allowing the MN to fetch the SPR). Step 660 can comprise multiple variations. In one embodiment, the SPR information availability is included in next RRCReconfigurationComplete message sent to the MN. In another embodiment, the SPR information availability is included in a RRC message e.g., UEInformationTransferMRDC message.

Another embodiment under method 600 can include steps performed by a network node acting as SN for a UE in Dual Connectivity operation. Step 690 is receiving an SPR from the MN. In one embodiment of step 690, UE-associated signaling is used, such as: a new UE-associated XnAP message; XnAP S-Node Modification Required message; or XnAP RRC Transfer message. In another embodiment, non UE-associated message is used, such as: XnAP Access and Mobility Indication message; or a new non UE-associated message.

### SN Signaling to the MN to Fetch SPR

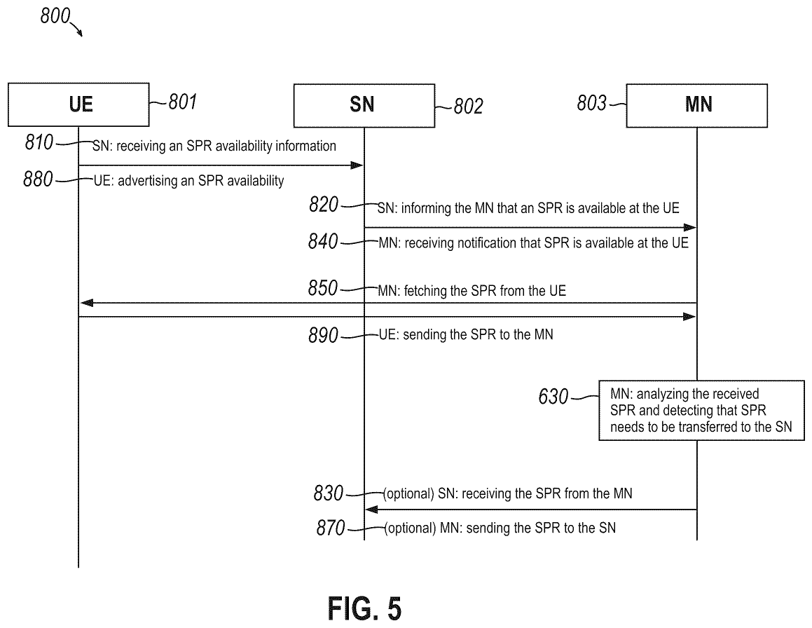

Another embodiment can include a SN signaling to a MN that SPR is to be fetched. Approaches under this embodiment can include new inter-node signaling, sent by the SN, to inform MN that an SPR is available at the UE. Alternative embodiments and variations can include, e.g., UE-associated signaling like S-Node Modification Required or the addition of a UE identifier; or inter-node signaling where MN forwards the SPR to the SN, together with a UE identifier. FIG. 5 illustrates a possible method embodiment 800, including steps from the perspective of the SN 802, UE 801, and MN 803.

One embodiment under method 800 includes steps performed by a network node acting as SN 802 for a UE 801 in Dual Connectivity operation. Step 810 is receiving an SPR availability information from the UE. Step 820 is informing the MN that a SPR is available at the UE. Step 830, optional, is receiving the SPR from the MN.

Another embodiment under method 800 can include steps performed by a network node acting as MN for a UE in Dual Connectivity operation. Step 840 is receiving from the SN an indication that an SPR is available at a UE. Step 850 is fetching the SPR from the UE. Step 860 is analyzing the received SPR and detecting that SPR needs to be transferred to SN. Step 870 is transferring the SPR to the SN.

Another embodiment under method 800 can include steps performed by a UE in Dual Connectivity operation. Step 880 is advertising an SPR availability information to the SN. Step 890, optional, can be sending the SPR to the MN in response to MN request/retrieval.

Step 810/880 can take a variety of embodiments or variations. In one embodiment, the SPR information availability is included in the RRCReconfigurationComplete message. In some variations, the RRCReconfigurationMessage can be sent directly from UE to SN (via SRB3); or the RRCReconfigurationMessage can be sent via the MN, in S-NODE RECONFIGURATION COMPLETE message from MN to SN (if received by the MN via SRB1).

Step 820/840 can take a variety of embodiments or variations. The SPR availability notification/indication can take multiple forms. In one embodiment, an SPR availability indication is included in an S-Node Modification Required message. In an alternative embodiment, an SPR availability indication is included in an Access and Mobility Indication message, together with an identifier uniquely identifying the UE for which the SPR is available. In another alternative embodiment, an SPR availability indication is included in a new XnAP message (e.g. SON Report Availability), sent to the MN. In another embodiment the SN requests MN to collect SPR for a list of the UEs with SPR. The SN includes a list of UE identifiers in the request to the MN.

Step 830/870 can take a variety of embodiments or variations. In one embodiment, the SPR is included in an S-Node Modification Confirm message. In an alternative embodiment, the SPR is included in an Access and Mobility Indication message, together with an identifier uniquely identifying the UE which generated the SPR.

Step 860 can take a variety of embodiments or variations. In one embodiment, the information that SPR needs to be transferred to SN is represented by the information that the PSCell Change was triggered by the SN, this information being contained in the SPR itself. In another embodiment, the information that SPR needs to be transferred to SN is represented by one or several triggers contained in the SPR, these triggers being configured by the SN prior to SPR generation.

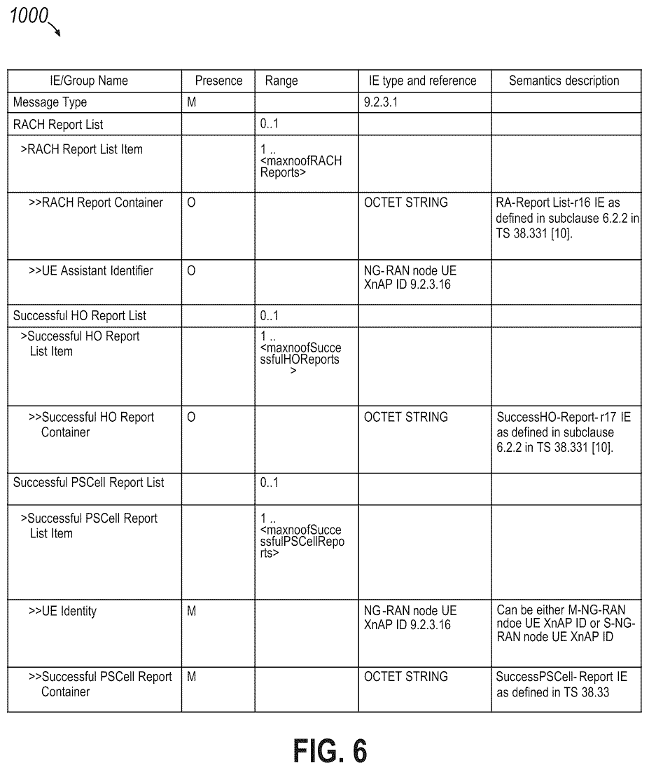

An example of a possible implementation of method 800 in TS 38.423, is shown in FIG. 6. FIG. 6 illustrates an embodiment of an access and mobility indication 1000. This message is sent by NG-RAN node 1 to transfer access and mobility related information to NG-RAN node 2. The direction is from NG-RAN node 1 to NG-RAN node 2.

### MN Fetches the SPR (SN-Initiated PSCell Change)

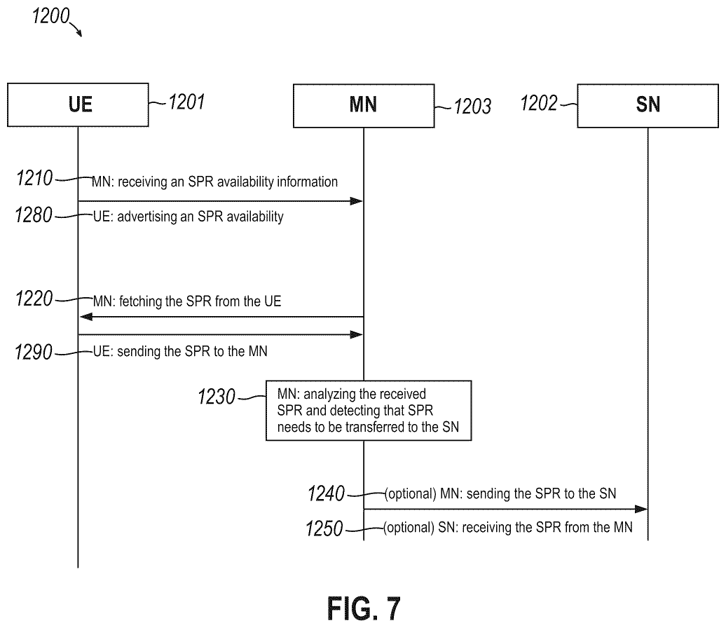

Another embodiment can include the MN fetching SPR and sending it to SN if needed, wherein the PSCell change was SN-initiated. Such embodiments can include a focus on the MN analyzing the SPR to determine if SPR needs to be transferred, by analyzing triggers contained in SPR. FIG. 7 illustrates a possible method embodiment 1200, including steps from the perspective of the SN 1202, UE 1201, and MN 1203.

One embodiment under method 1200 includes steps performed by a network node acting as Master Node (MN) for a UE in Dual Connectivity operation. Step 1210 is receiving an SPR availability information from the UE. Step 1220 is fetching the SPR from the UE. Step 1230 is analyzing the received SPR and detecting that SPR needs to be transferred to SN. Step 1240 is transferring the SPR to the SN.

Another embodiment under method 1200 includes steps performed by a network node acting as a SN. Step 1250 is receiving the SPR from the MN.

Another embodiment under method 1200 includes steps performed by a UE. Step 1280 is advertising/notifying an SPR availability to the MN. Step 1290, optional, is responding to a fetch of the SPR by the MN, or sending the SPR to the MN.

Step 1210/1280 can comprise different embodiments or variations. In one embodiment, the SPR information availability is included in the RRCReconfigurationComplete message. The RRCReconfigurationMessage can be sent directly from UE to MN (via SRB1). In another embodiment, the SPR information availability is included in a RRC message e.g., UEInformationTransferMRDC message. The UEInformationTransferMRDC can be directly sent from UE to MN (via SRB1).

Step 1230 can comprise different embodiments or variations. In one embodiment, the information that SPR needs to be transferred to SN is represented by the information that the PSCell Change was triggered by the SN, this information being contained in the SPR itself. In another embodiment, the information that SPR needs to be transferred to SN is represented by one or several triggers contained in the SPR, these triggers being configured by the SN prior to SPR generation. In another embodiment, the information that SPR needs to be transferred to SN which is represented by a flag triggering MN to send the SPR to SN upon reception of the SPR via SRB1.

Step 1240/1250 can comprise different embodiments or variations. In one embodiment, UE-associated signaling is used, such as: a new UE-associated XnAP message; XnAP S-Node Modification Request message; or XnAP RRC Transfer message. In other embodiments, non UE-associated message is used, such as: XnAP Access and Mobility Indication message; or a new non UE-associated message.

### Additional Embodiments

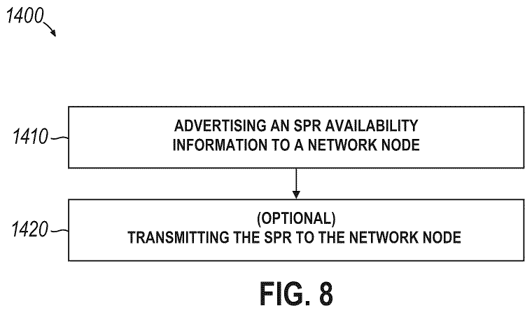

A possible method embodiment under the present disclosure is shown in FIG. 8. Method 1400 comprises a method performed by a UE for indicating availability of a SPR. Step 1410 is advertising an SPR availability information to a network node. It also optionally comprises step 1420, transmitting the SPR to the network node. Method 1400 can comprise multiple variations and embodiments and/or additional and/or alternative steps.

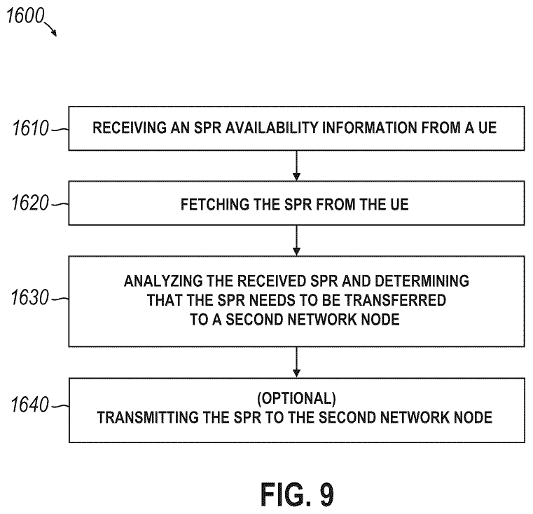

Another possible embodiment of a method under the present disclosure is shown in FIG. 9. Method 1600 is a method performed by a first network node for transmitting a SPR. Step 1610 is receiving an SPR availability information from a UE. Step 1620 is fetching the SPR from the UE. Step 1630 is analyzing the received SPR and determining that the SPR needs to be transferred to a second network node. The method 1600 further optionally comprises step 1640, transmitting the SPR to the second network node. Method 1600 can comprise multiple variations and embodiments and/or additional and/or alternative steps.

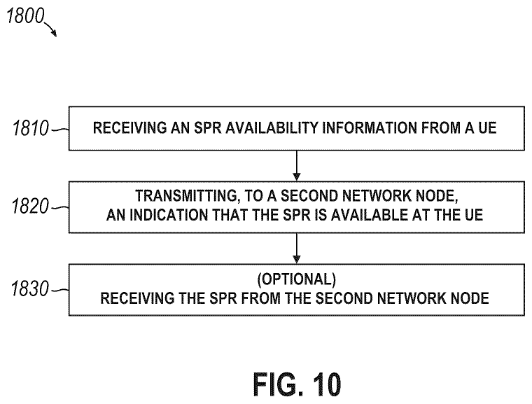

A further possible embodiment under the present disclosure is shown in FIG. 10. Method 1800 comprises a method performed by a first network node for indicating availability of a SPR. Step 1810 is receiving an SPR availability information from a UE. Step 1820 is transmitting, to a second network node, an indication that the SPR is available at the UE. The method 1800 can optionally further include step 1830, receiving the SPR from the second network node. Method 1800 can comprise multiple variations and embodiments and/or additional and/or alternative steps.

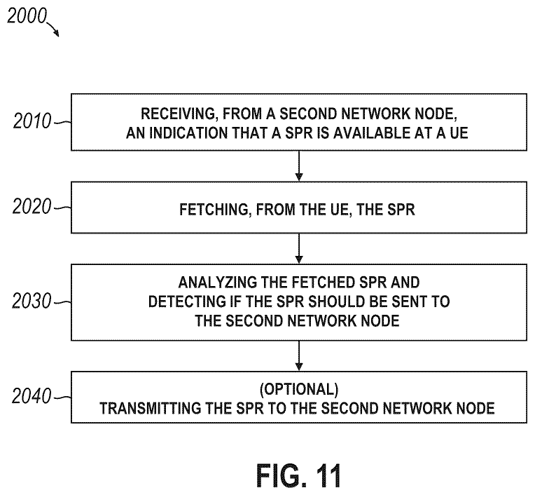

A further embodiment under the present disclosure is shown in FIG. 11. Method 2000 comprises a method performed by a first network node for receiving a SPR. Step 2010 is receiving, from a second network node, an indication that a SPR is available at a UE. Step 2020 is fetching, from the UE, the SPR. Step 2030 is analyzing the fetched SPR and detecting if the SPR should be sent to the second network node. The method 2000 can optionally further include step 2040, transmitting the SPR to the second network node. Method 2000 can comprise multiple variations and embodiments and/or additional and/or alternative steps. The one or more reselection priorities can comprise.

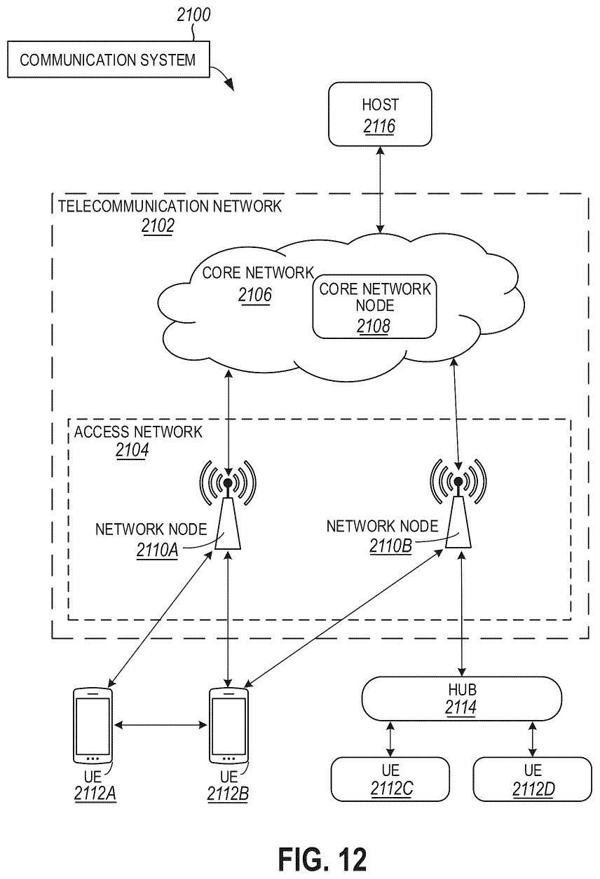

FIG. 12 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

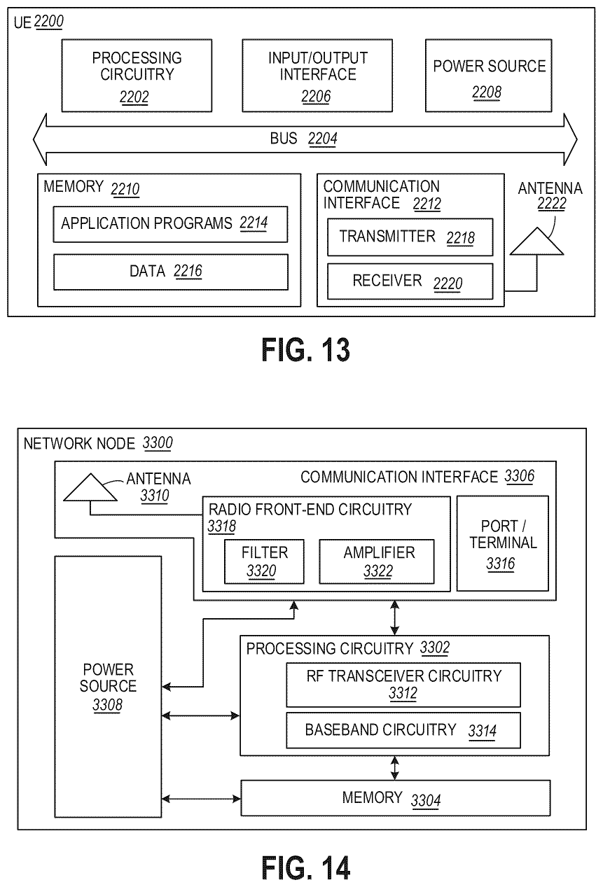

FIG. 13 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 14 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

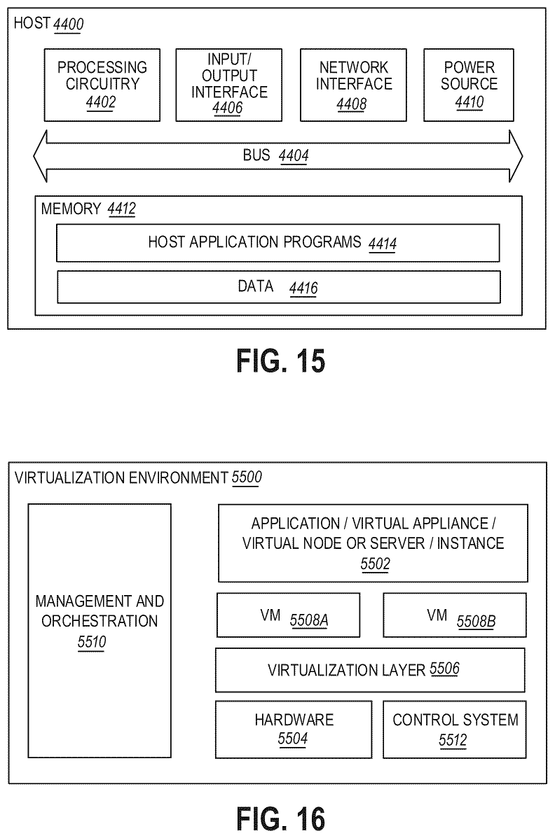

FIG. 15 is a block diagram of a host 4400, which may be an embodiment of the host 2116 of FIG. 12, in accordance with various aspects described herein. As used herein, the host 4400 may be or comprise various combinations hardware and/or software, including a standalone server, a blade server, a cloud-implemented server, a distributed server, a virtual machine, container, or processing resources in a server farm. The host 4400 may provide one or more services to one or more UEs.

The host 4400 includes processing circuitry 4402 that is operatively coupled via a bus 4404 to an input/output interface 4406, a network interface 4408, a power source 4410, and a memory 4412. Other components may be included in other embodiments. Features of these components may be substantially similar to those described with respect to the devices of previous figures, such as FIGS. 13 and 14, such that the descriptions thereof are generally applicable to the corresponding components of host 4400.

The memory 4412 may include one or more computer programs including one or more host application programs 4414 and data 4416, which may include user data, e.g., data generated by a UE for the host 4400 or data generated by the host 4400 for a UE. Embodiments of the host 4400 may utilize only a subset or all of the components shown. The host application programs 4414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 4414 may also provide for user authentication and licensing checks and may periodically report health, routes, and content availability to a central node, such as a device in or on the edge of a core network. Accordingly, the host 4400 may select and/or indicate a different host for over-the-top services for a UE. The host application programs 4414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

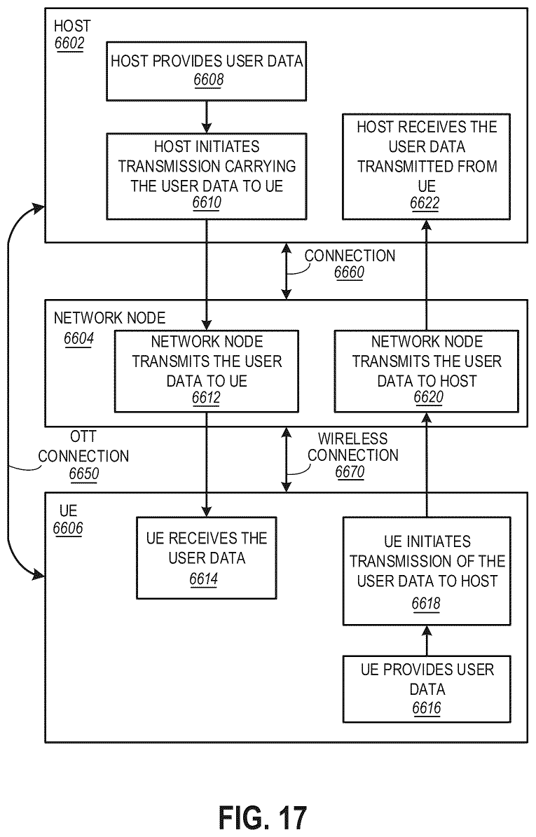

FIG. 17 shows a communication diagram of a host 6602 communicating via a network node 6604 with a UE 6606 over a partially wireless connection in accordance with some embodiments. Example implementations, in accordance with various embodiments, of the UE (such as a UE 2112a of FIG. 12 and/or UE 2200 of FIG. 13), network node (such as network node 2110a of FIG. 12 and/or network node 3300 of FIG. 14), and host (such as host 2116 of FIG. 12 and/or host 4400 of FIG. 15) discussed in the preceding paragraphs will now be described with reference to FIG. 17.

Like host 4400, embodiments of host 6602 include hardware, such as a communication interface, processing circuitry, and memory. The host 6602 also includes software, which is stored in or accessible by the host 6602 and executable by the processing circuitry. The software includes a host application that may be operable to provide a service to a remote user, such as the UE 6606 connecting via an over-the-top (OTT) connection 6650 extending between the UE 6606 and host 6602. In providing the service to the remote user, a host application may provide user data which is transmitted using the OTT connection 6650.

The network node 6604 includes hardware enabling it to communicate with the host 6602 and UE 6606. The connection 6660 may be direct or pass through a core network (like core network 2106 of FIG. 12) and/or one or more other intermediate networks, such as one or more public, private, or hosted networks. For example, an intermediate network may be a backbone network or the Internet.

The UE 6606 includes hardware and software, which is stored in or accessible by UE 6606 and executable by the UE's processing circuitry. The software includes a client application, such as a web browser or operator-specific “app” that may be operable to provide a service to a human or non-human user via UE 6606 with the support of the host 6602. In the host 6602, an executing host application may communicate with the executing client application via the OTT connection 6650 terminating at the UE 6606 and host 6602. In providing the service to the user, the UE's client application may receive request data from the host's host application and provide user data in response to the request data. The OTT connection 6650 may transfer both the request data and the user data. The UE's client application may interact with the user to generate the user data that it provides to the host application through the OTT connection 6650.

The OTT connection 6650 may extend via a connection 6660 between the host 6602 and the network node 6604 and via a wireless connection 6670 between the network node 6604 and the UE 6606 to provide the connection between the host 6602 and the UE 6606. The connection 6660 and wireless connection 6670, over which the OTT connection 6650 may be provided, have been drawn abstractly to illustrate the communication between the host 6602 and the UE 1606 via the network node 6604, without explicit reference to any intermediary devices and the precise routing of messages via these devices.

As an example of transmitting data via the OTT connection 6650, in step 6608, the host 6602 provides user data, which may be performed by executing a host application. In some embodiments, the user data is associated with a particular human user interacting with the UE 6606. In other embodiments, the user data is associated with a UE 6606 that shares data with the host 6602 without explicit human interaction. In step 6610, the host 6602 initiates a transmission carrying the user data towards the UE 6606. The host 6602 may initiate the transmission responsive to a request transmitted by the UE 6606. The request may be caused by human interaction with the UE 6606 or by operation of the client application executing on the UE 6606. The transmission may pass via the network node 6604, in accordance with the teachings of the embodiments described throughout this disclosure. Accordingly, in step 6612, the network node 6604 transmits to the UE 6606 the user data that was carried in the transmission that the host 6602 initiated, in accordance with the teachings of the embodiments described throughout this disclosure. In step 6614, the UE 6606 receives the user data carried in the transmission, which may be performed by a client application executed on the UE 6606 associated with the host application executed by the host 6602.

In some examples, the UE 6606 executes a client application which provides user data to the host 6602. The user data may be provided in reaction or response to the data received from the host 6602. Accordingly, in step 6616, the UE 6606 may provide user data, which may be performed by executing the client application. In providing the user data, the client application may further consider user input received from the user via an input/output interface of the UE 6606. Regardless of the specific manner in which the user data was provided, the UE 6606 initiates, in step 6618, transmission of the user data towards the host 6602 via the network node 6604. In step 6620, in accordance with the teachings of the embodiments described throughout this disclosure, the network node 6604 receives user data from the UE 6606 and initiates transmission of the received user data towards the host 6602. In step 6622, the host 6602 receives the user data carried in the transmission initiated by the UE 6606.

One or more of the various embodiments improve the performance of OTT services provided to the UE 6606 using the OTT connection 6650, in which the wireless connection 6670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 6602. As another example, the host 6602 may process audio and video data which may have been retrieved from a UE for use in creating maps. As another example, the host 6602 may collect and analyze real-time data to assist in controlling vehicle congestion (e.g., controlling traffic lights). As another example, the host 6602 may store surveillance video uploaded by a UE. As another example, the host 6602 may store or control access to media content such as video, audio, VR or AR which it can broadcast, multicast or unicast to UEs. As other examples, the host 6602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 6650 between the host 6602 and UE 6606, in response to variations in the measurement results. The measurement procedure and/or the network functionality for reconfiguring the OTT connection may be implemented in software and hardware of the host 6602 and/or UE 6606. In some embodiments, sensors (not shown) may be deployed in or in association with other devices through which the OTT connection 6650 passes; the sensors may participate in the measurement procedure by supplying values of the monitored quantities exemplified above, or supplying values of other physical quantities from which software may compute or estimate the monitored quantities. The reconfiguring of the OTT connection 6650 may include message format, retransmission settings, preferred routing etc. ; the reconfiguring need not directly alter the operation of the network node 6604. Such procedures and functionalities may be known and practiced in the art. In certain embodiments, measurements may involve proprietary UE signaling that facilitates measurements of throughput, propagation times, latency and the like, by the host 6602. The measurements may be implemented in that software causes messages to be transmitted, in particular empty or ‘dummy’ messages, using the OTT connection 6650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system-or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”') includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Conclusion

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A method performed by a user equipment, UE, for indicating availability of a Successful Primary Secondary Cell, PSCell, Report, SPR, the method comprising:
advertising an SPR availability information to a network node.

2.-3. (canceled)

4. The method of claim 1, wherein the SPR availability information is included in at least one of: a Radio Resource Control, RRC, message; a RRC Reconfiguration Complete, RRCReconfigurationComplete, message; an uplink information transfer multi-Radio Access Technology Dual Connectivity, ULInformation TransferMRDC, message; a S-NODE RECONFIGURATION COMPLETE message from a Master Node to a Secondary Node; Signaling Radio Bearer 1, SRB1; UE Assistance Information, UEAssistanceInformation, message.

5. The method of claim 1, wherein the SPR availability information is sent directly from the UE to a Secondary Node via Signaling Radio Bearer 3, SRB3.

6. The method of claim 1, wherein the SPR availability information is sent directly from the UE to a Master Node via Signaling Radio Bearer 1, SRB1.

7. The method of claim 1, wherein the SPR availability information is sent via a Master Node, MN, in a S-NODE RECONFIGURATION COMPLETE message from the MN to a Secondary Node if the SPR availability information was received by the MN via Signaling Radio Bearer 1, SRB1.

8. The method of claim 1, further comprising receiving a configuration of the SPR availability information from one or more of: a Master Node, MN; a Secondary Node, SN.

9. (canceled)

10. The method of claim 1, wherein the receiving is performed on at least one of: a Radio Resource Control, RRC message; a RRC Reconfiguration Complete, RRCReconfigurationComplete, message; or a UE Assistance Information, UEAssistanceInformation, message.

11. A method performed by a first network node for transmitting a Successful Primary Secondary Cell, PSCell, Report, SPR, the method comprising:
receiving an SPR availability information from a UE;
fetching the SPR from the UE; and
analyzing the received SPR and determining that the SPR needs to be transferred to a second network node; and
transmitting the SPR to the second network node.

12.-14. (canceled)

15. The method of claim 11, wherein the SPR availability information is included in at least one of: a Radio Resource Control, RRC, message; a RRC Reconfiguration Complete, RRCReconfigurationComplete, message; an uplink information transfer multi-Radio Access Technology Dual Connectivity, ULInformationTransferMRDC, message; a S-NODE RECONFIGURATION COMPLETE message from a Master Node to a Secondary Node; Signaling Radio Bearer 1, SRB1; UE Assistance Information, UEAssistanceInformation, message.

16. The method of claim 11, wherein the SPR availability information is sent directly from the UE to a Secondary Node via Signaling Radio Bearer 3, SRB3.

17. The method of claim 11, wherein the SPR availability information is sent directly from the UE to a Master Node via Signaling Radio Bearer 1, SRB1.

18.-32 (canceled)

33. A method performed by a first network node for receiving a Successful Primary Secondary Cell, PSCell, Report, SPR, the method comprising:
receiving, from a second network node, an indication that a SPR is available at a user equipment, UE;
fetching, from the UE, the SPR; and
analyzing the fetched SPR and detecting if the SPR should be sent to the second network node.

34. The method of claim 33, further transmitting the SPR to the second network node.

35.-36. (canceled)

37. The method of claim 33, wherein the SPR availability information is included in at least one of: a Radio Resource Control, RRC, message; a RRC Reconfiguration Complete, RRCReconfigurationComplete, message; an uplink information transfer multi-Radio Access Technology Dual Connectivity, ULInformationTransferMRDC, message; a S-NODE RECONFIGURATION COMPLETE message from a Master Node to a Secondary Node; Signaling Radio Bearer 1, SRB1; UE Assistance Information, UEAssistanceInformation, message.

38. The method of claim 33, wherein the SPR availability information is sent directly from the UE to a Secondary Node via Signaling Radio Bearer 3, SRB3.

39. The method of claim 33, wherein the SPR availability information is sent directly from the UE to a Master Node via Signaling Radio Bearer 1, SRB1.

40. The method of claim 33, wherein the SPR availability information is sent via a Master Node, MN, in a S-NODE RECONFIGURATION COMPLETE message from the MN to a Secondary Node if the SPR availability information was received by the MN via Signaling Radio Bearer 1, SRB1.

41. The method of claim 33, wherein the UE received a configuration of the SPR availability information from one or more of: a Master Node, MN; a Secondary Node, SN.

42. (canceled)

43. The method of claim 33, wherein the receiving by the UE was performed on at least one of: a Radio Resource Control, RRC, message; a RRC Reconfiguration Complete, RRCReconfigurationComplete, message; or a UE Assistance Information, UEAssistanceInformation, message.

44. (canceled)

45. A user equipment, UE, for indicating availability of a Successful Primary Secondary Cell, PSCell, Report, SPR, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of claims 1 to 10;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

46. (canceled)
